(19) United States
(12) Patent Application Publication
(10) Pub. No.: US 2007/0227404 A1
(43) Pub. Date: Oct. 4, 2007

(54) Method of using high-alumina cements for rheology control of liquid phases

(75) Inventors: Johann Plank, Trostberg (DE); Gregor Keilhofer, Tacherting (DE); Jurgen Heidlas, Trostberg (DE); Peter Lange, Obing (DE)

Correspondence Address: Fulbright & Jaworski L.L.P., 666 Fifth Avenue, New York, NY, 10103, US

(73) Assignee: BASF Construction Polymers GmbH, Trostberg (DE)

(21) Appl. No.: 11/590,660

(22) Filed: Oct. 30, 2006

(30) Foreign Application Priority Data
Mar. 29, 2006 (DE) 10 2006 014 403.1

(51) Int. Cl. C04B 28/06; C04B 14/00

(52) U.S. Cl. 106/694; 106/811

(57) ABSTRACT

Rheological control of liquid phases is provided with a composition comprising a high-alumina cement component a) for controlling the rheology of liquid phases based on a clay component b). Component a) is preferably a calcium aluminate cement and component b) is preferably a clay of the smectite variety. The compositions comprise at least 20% by weight representative of the calcium aluminate cement and is preferably used for rheology control of water- or oil-based systems.

### BACKGROUND AND SUMMARY OF THE INVENTION

The present application claims priority from German patent application 10 2006 014 403.1 filed Mar. 29, 2006, incorporated herein by reference in its entirety.

The present invention relates to a method of use of a high-alumina cement component a) for controlling the rheology of liquid phases based on a clay component b).

The controlled thickening of water- and oil-based systems, so-called rheology control, is a customary technological measure and it is utilized in industrial practice on a relatively large scale by using various additives of natural or synthetic origin. Independently of the various fields of use, the shear-diluting and/or thixotropic thickening of the respective liquid phase is often of primary importance.

For example, hydrophilic or hydrophobic polymers and biopolymers, such as, in particular, scleroglucan, xanthan gum, acrylic acid copolymers or polymethacrylates, are frequently used for rheology control of water- or oil-based drilling fluids in the exploration of petroleum and natural gas. It is known to the skilled person that particularly shear-thinning drilling fluids enable the efficient transport of drill cuttings from down-hole. The rheological profile of the liquid phase can, for drilling applications be of importance in different aspects: in addition to said improvement of the cutting carrying capacity which also correlates with a good pumpability, shear-thinning fluids can also reduce the filtrate loss, stabilize the borehole in the drilled formations and support an easy separation of the drill cuttings from the drilling.

Widespread in the industry is for rheology control the use of clay of the so-called Smectite-type such as, for example, bentonite and especially those types which are distinguished by a high content of montmorillonite, being especially preferred. Use is also made here of additional, secondary additives in order further to enhance the basic rheology of the clay component. For example, organic polymers such as partially hydrolysed polyacrylamide (PHPA), are customary used as “bentonite extenders”, which either may be added to the aqueous clay suspension or more commonly are supplied as a ready-to-use mixture jointly with the clay component (see “Composition and Properties of Drilling and Completion Fluids”, 5th Edition, Darley H. C. H. & Gray G. R., Gulf Publishing Company, Houston, Tex., page 178).

Also so-called mixed metal oxides (MMO) or mixed metal hydroxides (MMH) are frequently used to enhance and boost the rheological profile of clay suspensions by an additional thickening of the initially introduced clay suspension. Such clay-MMO/MMH-based liquids are very valuable in the area of drilling technology since they have an excellent cutting carrying capacity and enable an easy removal of drill cutting from the drilling fluids in the exploration of natural gas and petroleum wells.

Mixed metal oxides and mixed metal hydroxides are familiar to the person skilled in the art and are also sufficiently documented by the prior art (WO 01/49 406 A1, DE 199 33 179 A1). The strict definition of the terms “mixed metal oxide” (MMO) and “mixed metal hydroxides” (MMH) derives primarily from their synthetic route but—in the second instance—also from their use and application in combination with a clay component and in particular in association with rheology control of liquid phases. However, it can be assumed that, independent of the description of the mixed metal component used in each case, a mixed metal hydroxide having a layer structure is always present in situ or the mixed metal hydroxide forms by hydration processes. As a rule, these are hydrotalcites or hydrotalcite-like compounds based on magnesium-aluminium, which may also be thermally activated or calcined and then hydrated.

The predominantly positive charged surfaces of these clay-like minerals can, based on the properties described above, interact with common clays and form adducts or network-type structures, which eventually induce an increase in the viscosity in the liquid phase.

The preparation of corresponding liquid phases based on clay and water and in particular with the use of mixed metal compounds is described in WO 01/49 406 A1. A number of further examples which illustrate the use of mixed metal oxides (MMO) or mixed metal hydroxides (MMH) in association with the thickening of an initially introduced clay suspension are to be found in EP 0 539 582 B1 and DE 199 33 176 A1.

According to EP 0 539 582 B1, the mixed metal hydroxides, together with bentonite, form adducts, while, according to DE 199 33 176 A1, the mixed metal hydroxides described there, together with hectorite, form adducts which are suitable in each case for rheology control of liquid phases.

U.S. Pat. No. 6,906,010 describes formulations for rheology modification in liquids, which are used in drilling for oil and gas and in tunnel construction. Such aqueous liquids having rheology-modifying properties contain clay, water, magnesium oxide, aluminium oxide hydroxide, sodium or potassium carbonate and calcium oxide or calcium hydroxide. It may be assumed in this context that the liquid phases having such a composition are likewise based on in-situ production of a mixed metal hydroxide.

An additional alternative for in-situ produced mixed metal hydroxide is disclosed by EP 0 167 106 A1. An appropriate starting material comprises a metal aluminate such as sodium aluminate together with a magnesium compound such as magnesium oxide. Regarding such in-situ produced MMH the disclosure of EP 0 617 106 A1 is incorporated herein by reference in its entirety. Further, specific MMH species are also disclosed by WO 94/02556. Typical compounds are represented by minerals of the so-called granat type and preferably katoites which can bear a certain proportion of silica groups. An alternative name of these MMH is “mixed metal silicate”. The disclosure of WO 94/02556 is incorporated herein by reference in its entirety.

The thickening of, as a rule, aqueous clay suspensions with the aid of mixed metal oxides and mixed metal hydroxides thus constitutes prior art which has been sufficiently well described in the past. By simply mixing them together, adducts and network structures form which are based on electrostatic interactions between the clay component and the MMO/MMH components, resulting in the so-called shear-thinning rheology.

The aforementioned additives are special products which are particularly produced only for the designated and described application for rheology control of water- or oil-based liquid phases. For example, due to the sophisticated preparation process and limited production capacities in some cases, MMH/MMO-based products have experienced a continuous price increase recently.

It was the object of the present invention to provide a practical alternative for controlling the rheology of liquid phases based on a clay component. This novel system should be as simple as possible regarding its composition and, for economic reasons, should rely on known, and readily available starting materials. The performance in rheology control should be at least equivalent to the systems known to date.

This object was achieved by the use of high-alumina cement component a) for controlling the rheology of liquid phases based on a clay component b). The high alumina cement has an alumina content of 30% or more by weight of the cement, and preferably at least 60% by weight alumina content.

Surprisingly, it has been found that, commercially available high-alumina cements are extraordinarily suitable for thickening an initially introduced clay suspension. This is in particular surprising since these high-alumina cements develop this desired effect even in extremely small concentrations, what indicates that the conventional mechanism of action known from cement chemistry do not play a role in this particular instance of the invention.

### DETAILED DESCRIPTION

High-alumina cements have been known to date in construction chemistry generally in association with refractory applications and with quick-setting mortars. High-purity calcium-aluminate cements show a rapid hardening, as they can be even further accelerated in their setting behavior by lithium salts. It is also known that high-alumina cements have high acid resistance. Moreover, in contrast to Portland cement, their shrinkage behavior can be greatly minimized by addition of sulphate carriers, that is, for example, anhydrite (CaSO₄). High-alumina cements display their various modes of action independently of climatic influences and with constant good stability.

The dominant so-called “hydraulic mineral” in calcium aluminate cements is calcium monoaluminate. Its hydration is responsible for the high early strength. Calcium monoaluminate comprises monoclinic phases having a pseudohexagonal structure. A further variant comprises calcium dialuminates, which are also referred to as grossites. In comparison with the abovementioned calcium monoaluminates, grossites are less reactive but more refractory. The hydration of grossites is accelerated by higher temperatures, proportions of calcium monoaluminate not presenting problems. Mayenites, which, in the form of dodecacalcium heptaaluminates, are the most reactive of all calcium aluminate variants, are also known. Certain mayenites undergoing extremely rapid hydration. Sintering of calcium dialuminates gives calcium hexaaluminates. These are not hydraulic but are extremely refractory and they have a melting point of 1870° C.

In addition to refractory materials, the fields of use of calcium aluminate cements also comprise special floor coverings, such as, for example, so-called self-levelling materials and chemically resistant mortars and concretes. High-alumina cements are also present in expansive cements, screeds, tile adhesives and protective coating materials.

In the area of petroleum and natural gas applications, high-alumina cements are occasionally used for cementing wells. However, applications in drilling fluids are not known to date.

Within the scope of the present invention, the use of a high-alumina cement component has proved to be particularly advantageous and the respective liquid phase is one based on smectites, bentonites, montmorillonites, beidellites, hectorites, saponites, sauconites, vermiculites, illites, kaolinites, chlorites, attapulgites, sepiolites, palygorskites, halloysites and Fuller's earths as clay component b). The component a) displays its advantageous properties in particular when the component b) comprises clays of the smectite type and in particular hectorite and particularly preferably montmorillonites and bentonites.

The present invention envisages a further variant in which the clay component used also contains additives, such as, in particular, partially hydrolyzed polyacrylamides (PHPA) as so-called “bentonite extenders”. It is also envisaged that the clay component used may be chemically modified, said component then preferably comprising clays which have been rendered hydrophobic, especially for use in oil-based drilling fluids.

For purposes of the present invention, the term “high alumina cement” is a calcium aluminate cement having an alumina content of at least 30% by weight and preferably at least 60% by weight alumina content. High-alumina cements are sometimes also referred to in the art as calcium aluminate cement and aluminous cement.

Regarding the high alumina cement component a) essential to the invention, the present invention takes into account, as preferred exemplary members, calcium aluminate cements and here in particular, wherein in the formulas provided C and A represent complex calcium and alumina oxides containing mixed phases, calcium monoaluminate cements of formula CA, calcium dialuminate cements of the formula CA₂ (“grossites”), dodecacalcium heptaaluminate cements of the formula C₁₂A₇ (“mayenites”) and/or calcium hexaaluminate cements of the formula CA₆ (“hibonites”). For the intended use according to the invention, however, hydration products of the above-described high-alumina cements are also very suitable. In particular CAH₁₀C₂AH₈ and C₄H₁₃ may be mentioned as exemplary typical members in this context. In these abbreviations customary in the industry, C and A are as set forth above and H represents the proportions of water of hydration. These hydration products can be used in the respective application either as the sole representative of the high-alumina cement component or in any suitable mixture with nonhydrated high-alumina cements.

It has proved to be particularly advantageous if the component a) comprises at least one representative of the calcium aluminate cements in proportions of ≧30% by weight and preferably ≧50% by weight, the total aluminate content being required to be ≧30% by weight and preferably ≧60% by weight.

In other preferred embodiments, the high-alumina cement contains at least 35% by weight, also preferably at least 40% by weight, more preferably at least 50% by weight, and also preferably at least 52% by weight aluminate. In other preferred embodiments, the high-alumina cements according to the invention have an aluminate content of from at least 60% by weight, at least 70% by weight, at least 80% by weight or at least 90% by weight. In yet other preferred embodiments, the high-alumina cements according to the invention contain 40 to 95% alumina by weight, particularly preferably at least 70 to 75% by weight. In particularly preferred embodiment, the high-alumina cements contain from 35 to 95% by weight alumina.

According to the present invention, high-alumina cements can be added in relatively large ranges of concentration in order to control the rheology of the respective liquid phases. However, concentrations of ≦10% by weight and in particular ≦5% of the liquid phase by weight have been found to be particularly advantageous. Under particular conditions, the component a) can also be used in concentrations between 0.1 and 1.0% by weight, based in each case on the liquid phase, which is likewise taken into account by the present invention.

Regarding the liquid phase, the present invention envisages that it comprises water- and/or oil-based systems and emulsions or invert emulsions. Such systems are understood in particular as meaning water-based liquid phases which, in addition to fresh water or seawater, may contain a number of further main or secondary components; these also include salt-containing systems (so-called “brines”) and more complex drilling fluids, such as, for example, emulsions or invert emulsions, which may also contain large proportions of an oil component.

In particular, the liquid phase should comprise drilling fluids which, in addition to the main components a) and b) according to the present invention, contain further additives for controlling the rheology, for filtrate reduction, for controlling the density, the cooling and lubrication of the drill bit and for stabilizing the well wall. Furthermore, additives for chemical stabilization of the drilling fluid, such as, for example, radical scavengers or polyvalent metal salts, are frequently also used as so-called “anionic scavengers”.

A final preferred aspect of the present invention is that the use according to the invention serves for shear-thinning and/or thixotropic thickening of the liquid phase.

Overall, the use of high-alumina cements for rheology control of liquid phases provides a simple and cost-efficient novel approach which enables to rely on commercially available raw materials which additionally display the desired effect even in small dosages, said compounds having a relatively broad tolerance to the known crucial parameters, such as temperature and salt concentration.

The following examples of preferred embodiments illustrate the advantages of the present invention.

### EXAMPLES

The properties of the respective drilling fluids based on an aqueous clay suspension were determined according to the methods of the American Petroleum Institute (API), Guideline RP13B-1. Thus, the rheologies were measured using a FANN viscometer at 600 and 300 revolutions per minute, from which the values for PV (plastic viscosity) and YP (yield point) are calculated. In addition, the shear stresses at 200, 100, 6 and 3 revolutions per minute were determined. A reference experiment without high-alumina cement was also always carried out.

The following tables illustrate the results.

### Example 1

Variation of the High-Alumina Cement Component Used.

The thickening of an aqueous clay suspension customary in drilling technology for generating shear-diluting rheology which is distinguished by a high yield point YP in combination with low plastic viscosity (YP>>PV) is shown.

### Preparation of the Drilling Fluids:

350 g of water were initially introduced into a Hamilton Beach Mixer (HBM), “low” speed, and stirred together with 8 g of Wyoming Bentonite for 30 minutes. In each case 0.8 g of the high-alumina cement component was then added (e.g. Secar® 71 and Fondu® from Lafarge). The pH was adjusted to values between 11.0 and 11.5 with sodium hydroxide solution as a base and, after stirring for 15 minutes, was appropriately adjusted again. After stirring for a further 30 minutes, the rheology was measured.

TABLE 1

| 8 ppb of Wyoming | | | |
|---|---|---|---|
| Bentonite | | | |
| 0.8 ppb of | | | |
| high-alumina cement | FANN rheology at | | |
| pH 11 to 11.5 with | 600-300-200-100-6-3 rpm | PV | YP |
| NaOH: | [lbs/100 ft²] | [cP] | [lbs/100 ft²] |
| Secar ® 71: | 80-75-70-67-23-21 | 5 | 70 |
| Fondu ® Lafarge: | 72-61-48-38-18-14 | 11 | 50 |
| Reference experiment | 6-4-2-1-0-0 | 0 | 0 |
| without high-alumina | | | |
| cement: | | | |

ppb = pounds per barrel = dose [g] per 350 g of water

### Example 2

Variation of the clay component with an analogous experimental procedure according to Example 1.

Gold Seal Bentonite from Baroid, M-I Supreme Gel from M-I, Black Hills Bentonite from Black Hills Bentonite, a chemically treated OCMA clay and Bentone CT, a hectorite clay from Elementis were used. The individual doses of the clay component and of the high-alumina cement component were appropriately adapted in order to obtain a uniform yield point YP greater than 50 lbs/100 ft².

TABLE 2

| x ppb of clay | | | |
|---|---|---|---|
| component | | | |
| x/10 ppb of Secar 71 | FANN rheology at | | |
| pH 11 to 11.5 with | 600-300-200-100-6-3 rpm | PV | YP |
| NaOH: | [lbs/100 ft²] | [cP] | [lbs/100 ft²] |
| 8 ppb of Gold Seal | 80-75-70-67-23-21 | 5 | 70 |
| Bentonite: | | | |
| 8 ppb of M-I Supreme | 85-73-58-52-25-18 | 12 | 61 |
| Gel: | | | |
| 7 ppb of Black Hills | 93-80-72-60-28-23 | 13 | 67 |
| Bentonite: | | | |
| 11 ppb of OCMA clay: | 65-58-42-35-23-21 | 7 | 51 |
| 10 ppb of Bentone CT | 62-57-50-41-18-12 | 5 | 52 |
| hectorite: | | | |

### Example 3

Example 3 demonstrates various possibilities for pH adjustment with an analogous experimental procedure according to Example 1.

Aqueous NaOH (20% strength), commercially available sodium carbonate Na₂CO₃ and a stoichiometric 1:1 mixture of calcium oxide CaO and sodium carbonate were used as the base. In the case of the solids, sodium carbonate and the combination [CaO+sodium carbonate], a ready-to-use mixture with the high-alumina cement component was used in each case. Here, no further pH adjustment was made in the course of mixing.

TABLE 3

| | FANN rheology at | | |
|---|---|---|---|
| | 600-300-200-100-6-3 rpm | PV | YP |
| Components: | [lbs/100 ft²] | [cP] | [lbs/100 ft²] |
| 8 ppb of Wyoming | 80-75-70-67-23-21 | 5 | 70 |
| Bentonite | | | |
| 0.8 ppb of Secar ® 71 | | | |
| pH 11 to 11.5 with | | | |
| NaOH | | | |
| 9 ppb of Wyoming | 80-72-68-60-28-21 | 8 | 64 |
| Bentonite | | | |
| 0.9 ppb of Secar ® 71 | | | |
| 1.0 ppb of sodium | | | |
| carbonate Na₂CO₃ | | | |
| 8 ppb of Wyoming | 77-67-51-45-15-12 | 10 | 57 |
| Bentonite | | | |
| 0.8 ppb of Secar ® 71 | | | |
| 1.0 ppb of [sodium | | | |
| carbonate + | | | |
| CaO] (1:1) | | | |

### Example 4

Example 4 shows the use of seawater in the preparation of a liquid phase according to the invention.

182 g of a so-called “stock slurry” consisting of 30 g of a Wyoming Bentonite prehydrated in 350 g of fresh water are mixed with seawater in a ratio of 1:1. 1.5 g of the high-alumina cement component Secar® 71 were then added. The pH was adjusted to values between 11.0 and 11.5 with sodium hydroxide solution as a base and, after stirring for 15 minutes, was appropriately adjusted again. After stirring for a further 30 minutes, the rheology was measured.

TABLE 4

| | FANN rheology at | | |
|---|---|---|---|
| | 600-300-200-100-6-3 rpm | PV | YP |
| Composition: | [lbs/100 ft²] | [cP] | [lbs/100 ft²] |
| 182 g of “stock slurry” | 67-63-60-58-40-32 | 4 | 59 |
| (cf. above) | | | |
| 182 g of seawater | | | |
| 1.5 g of Secar ® 71 | | | |
| pH 11 to 11.5 with | | | |
| NaOH | | | |

### Example 5

Example 5 illustrates the insensitivity of high-alumina cement-containing fluid systems according to the invention to contamination customary in drilling technology, such as, for example, RevDust a low-swelling clay which is commonly used for simulating drilled solids, or to a hardened ground cement which forms during so-called “milling” operations which means the cutting out of damaged casing. The experiments are initially carried out according to Example 1, said contaminants being mixed in the last step:

TABLE 5

| | FANN rheology at | | |
|---|---|---|---|
| | 600-300-200-100-6-3 rpm | PV | YP |
| Components: | [lbs/100 ft²] | [cP] | [lbs/100 ft²] |
| 8 ppb of Wyoming | 67-59-55-49-34-27 | 8 | 51 |
| Bentonite | | | |
| 0.8 ppb of Secar ® 71 | | | |
| pH 11 to 11.5 with | | | |
| NaOH | | | |
| 20 ppb of RevDust | | | |
| 10 ppb of Wyoming | 95-85-75-60-28-18 | 10 | 75 |
| Bentonite | | | |
| 1.0 ppb of Secar ® 71 | | | |
| pH 11 to 11.5 with | | | |
| NaOH | | | |
| 20 ppb of hardened, | | | |
| ground cement | | | |

### Example 6

Example 6 illustrates the suitability of high-alumina cement-containing fluid systems according to the invention for use as drilling fluid which may also contain other functional additives, such as, for example, for filtrate water control.

The experimental procedure and the mixing of the basic fluid were initially effected according to Example 1, 20 g of RevDust for simulating drillings and 3.5 g of a derivatized polysaccharide, the product FLOPLEX® from M-I, finally being mixed in for filtrate water control. After measurement of the rheology, the so-called “API fluid loss” was determined according to appropriate guidelines.

TABLE 6

| | FANN rheology at | | |
|---|---|---|---|
| | 600-300-200-100-6-3 rpm | PV | YP |
| Components: | [lbs/100 ft²] | [cP] | [lbs/100 ft²] |
| 10 ppb of Wyoming | 68-60-54-45-32-27 | 8 | 52 |
| Bentonite | | | |
| 1.0 ppb of Secar ® 71 | | | |
| pH 11 to 11.5 with | | | |
| NaOH | | | |
| 20 g of RevDust | | | |
| 3.5 ppb of | | | |
| FLOPLEX ® | | | |

API fluid loss = 6 ml

The preceding examples illustrate but do not limit the breadth of the present invention with regard to the different high-alumina cement types, various clays and bases for pH adjustment and in principle with regard to different compositions of the basic liquid phase.

It is claimed:

1. A method comprising controlling rheology of a liquid phase comprising a clay component b) by adding a sufficient amount of a high-alumina cement component a) to the liquid phase to control the rheology of the liquid phase.

2. The method according to claim 1, wherein the clay component b) comprises smectites, bentonites, montmorillonites, beidellites, hectorites, saponites, sauconites, vermiculites, illites, kaolinites, chlorites, attapulgites, sepiolites, palygorskites, halloysites and Fuller's earths and preferably clays of the smectite type, in particular hectorite, and particularly preferably montmorillonites and bentonites.

3. The method according to claim 1, wherein the clay component comprises an additive selected from the group consisting of a partially hydrolysed polyacrylamide (PHPA) as a “bentonite extender”, an additive that is chemically modified, or is a clay component which has been rendered hydrophobic for use in oil-based drilling fluids.

4. The method according to claim 1, wherein component a) is selected from the group consisting of a calcium monoaluminate cement, a calcium dialuminate cement, a dodecacalcium heptaaluminate cement and a calcium hexaaluminate cement or a hydration product thereof.

5. The method according to claim 1, wherein component a) comprises at least 20% by weight of at least one calcium aluminate cement.

6. The method according to claim 1, wherein the component a) is present in an amount of ≦10% by weight based on the liquid phase.

7. The method according to claim 1, wherein the liquid phase is a water-based system, an oil-based system, an emulsion or an invert emulsion.

8. The method according to claim 1, wherein the liquid phase comprises drilling fluids further comprising at least one further additive for controlling the rheology, for filtrate reduction, for controlling the density, the cooling and lubrication of the drill bit, for stabilizing the well wall or for chemically stabilizing the drilling fluid.

9. The method according to claim 1, wherein the amount of component a) is sufficient to provide for the shear-thinning or thixotropic thickening of the liquid phase.

10. The method according to claim 1, wherein component a) comprises at least 30% by weight of at least one calcium aluminate cement.

11. The method according to claim 1, wherein component a) comprises at least 50% by weight of at least one calcium aluminate cement.

12. The method according to claim 1, wherein component a) comprises at least 90% by weight of at least one calcium aluminate cement.

13. The method of claim 6, wherein component a) is present in an amount of less than or equal to 5% by weight based on the liquid phase.

14. The method of claim 13, wherein component a) is present in an amount of from 0.1 to 1.0% by weight of the liquid phase.

15. The method according to claim 1, wherein component a) comprises from 20% to 90% by weight of said at least one calcium aluminate cement.

16. The method of claim 15, wherein the high alumina cement comprises from 30 to 90% by weight alumina.

17. The method of claim 16, wherein the high alumina cement comprises from 30 to 60% by weight alumina.

18. The method of claim 1, wherein component a) is selected from the group consisting of a calcium monoaluminate cement, a calcium dialuminate cement, a dodecacalcium heptaalumiante cement and a calcium hexaalumiante cement.
